(19) United States
(12) Patent Application Publication
(10) Pub. No.: US 2004/0071145 A1
(43) Pub. Date: Apr. 15, 2004

(54) Apparatus and method for UBR traffic control

(75) Inventors: Sung Woo Ha, Seongnam-si (KR); Jong Geun Ham, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/624,521

(22) Filed: Jul. 23, 2003

(30) Foreign Application Priority Data
Apr. 10, 2003 (KR) 0022747/2003
Jul. 27, 2002 (KR) 0044452/2002

(51) Int. Cl. H04L 12/56

(52) U.S. Cl. 370/395.43; 370/395.7

(57) ABSTRACT

UBR traffic control apparatus and methods can control UBR bandwidth according to cell traffic state and congestion occurrence at the switch terminal. Preferred embodiments can include an egress subscriber terminal that monitors congestion of cells at the switch terminal and traffic state to generate UBR bandwidth information, and an ingress subscriber terminal that outputs UBR cells to the switch terminal according to the generated UBR bandwidth information. Preferred embodiments can increase or maximize UBR traffic by flexibly increasing, decreasing or maintaining UBR bandwidth in consideration of the cells' congestion experience at the switch terminal, the egress subscriber terminal's buffer threshold value and traffic load. By managing cell traffic state for each transmitting subscriber board and by determining subscriber boards to be controlled in consideration of the traffic state at the time of UBR bandwidth's increase or decrease, the preferred embodiments may improve the quality of UBR service.

### BACKGROUND OF THE INVENTION

1. Field of the Invention

The present invention relates to UBR (Unspecified Bit Rate) traffic control in an ATM (Asynchronous Transfer Mode) switching device. In particular, the present invention relates to a UBR traffic control apparatus and method, that can reduce cell traffic congestion at an ATM switch and increase the UBR traffic efficiency at the receiving terminal to increase capacity.

2. Background of the Related Art

Generally, an ATM switch, which links user cells from the ingress subscriber terminal to the egress subscriber terminal in an ATM switching device, must process various types of traffic including sound, data or image signals in a manner that satisfies the relevant QoS (Quality of Service) standards.

ATM services may be classified into the following three categories: (i) the CBR (Constant Bit Rate) service, the nrt-VBR (non real-time Variable Bit Rate) service, and the rt-VBR (real-time Variable Bit Rate), which guarantee the QoS at the call request stage; (ii) the ABR (Available Bit Rate) service, which conducts transmission by using the available bandwidth of the link remaining after the above-described QoS—guaranteed services use the assigned bandwidth; and (iii) the UBR (Unspecified Bit Rate) service, which does not guarantee the QoS.

The UBR service, for which the bandwidth is not assigned at the time of connection, may be provided when there is some extra bandwidth available in the network. If traffic congestion occurs while the UBR service is provided, the UBR service is abandoned first.

However, if any of the cells constituting a packet is abandoned at the switch in a switching device experiencing congestion, the user at the destination deems the entire packet to have been damaged and requests retransmission. Thus, the effective packet output rate in the network decreases and the network resources are wasted. Therefore, in order to prevent traffic congestion from causing the above problems, it is necessary to control the UBR traffic.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to increase, maintain or decrease UBR bandwidth according to cell traffic state and depending on the traffic congestion and, thus, increases or maximizes the UBR traffic efficiency.

An embodiment of the present invention improves the UBR service quality by managing a cell traffic state for each transmitting subscriber board, determining the subscriber boards to be controlled according to the traffic state and feeding the UBR bandwidth information to the relevant subscriber boards, thereby preventing the UBR bandwidth from being reduced indiscriminately at all of the transmitting subscriber boards. Another embodiment improves the UBR traffic efficiency by using the cell traffic state information for the relevant transmitting subscriber board to prevent UBR bandwidth information from being fed-back to subscriber boards actually having no traffic at the time of the UBR bandwidth increase and by omitting the action of feed-backing UBR bandwidth information at the time when UBR bandwidth is maintained, thereby preventing the load increase caused by control cells.

Another embodiment provides a UBR traffic control apparatus that can include an egress subscriber terminal that repeatedly monitors cell congestion state and traffic state of cells output from a switch terminal, generates UBR bandwidth information corresponding thereto, and feeds-back the UBR bandwidth information; and an ingress subscriber terminal that outputs UBR cells to the switch terminal according to the fed-back UBR bandwidth information.

Preferably, if the congestion information indicates that there has been no congestion, a traffic state determination unit can increase the UBR bandwidth by first rate or by a second rate, which is smaller than first rate, according to the traffic load confirmed through the traffic load information. Further preferably, if the traffic load is not greater than a first load value, the traffic state determination unit increases the UBR bandwidth by applying the first rate; if the traffic load is greater than the first load value and is not greater than a second value, a traffic state determination unit can increase the UBR bandwidth by applying the second rate; and if the traffic load exceeds the pre-determined upper load value, the current UBR bandwidth is maintained.

Another embodiment provides a UBR traffic control apparatus that can include an egress subscriber terminal that determines UBR bandwidth periodically according to cell congestion experience and traffic state of cells output from a switch terminal, determines subscriber boards that are to be controlled based upon cell count information for each subscriber board in case of the increase or decrease in the UBR bandwidth and feed-backs the UBR bandwidth information to the determined subscriber boards to be controlled; and an ingress subscriber terminal that outputs UBR cells to the switch terminal according to the fed-back UBR bandwidth information.

Another embodiment provides a UBR traffic control method according to the present invention that can include determining, at an egress subscriber terminal, UBR bandwidth periodically according to cell congestion experience and traffic state of cells output from a switch terminal and feeding-back the determined UBR bandwidth; and outputting, at an ingress subscriber terminal, UBR cells to the switch terminal according to the fed-back UBR bandwidth information.

Preferably, the determination of UBR bandwidth can include confirming whether there is traffic congestion experience in the cell; if there has been traffic congestion, confirming whether the pre-determined buffer threshold value of the cell has been exceeded and, if the buffer threshold value has been exceeded, decreasing the UBR bandwidth to UBR available bandwidth; and if there has been no traffic congestion in the cell or if there has been traffic congestion but the buffer threshold value has not been exceeded, increasing the UBR bandwidth according to the traffic load of the cell. Preferably, the increasing of the UBR bandwidth can include confirming the traffic load of the cell; if the traffic load is not greater than the pre-determined minimum load value, increasing the UBR bandwidth by applying Increase Rate 1 which is a certain specific bandwidth increase rate; and if the traffic load is greater than the minimum load value and is not greater than the pre-determined maximum load value, increasing the UBR bandwidth by applying Increase Rate 2 which is smaller than said Increase Rate 1. Preferably, if the traffic load exceeds the maximum load value, the increasing of the UBR bandwidth can include maintaining of the current UBR bandwidth.

Another embodiment provides a UBR traffic control method according to the present invention that can include periodically counting, at an egress subscriber terminal, cells output from a switch terminal for each transmitting subscriber board; determining UBR bandwidth according to congestion experience at the switch terminal and traffic state of the cells; if the UBR bandwidth is increased or decreased, determining subscriber boards to be controlled by using the cell count information for each subscriber board; feeding-back the increased or decreased UBR bandwidth information to the subscriber boards to be controlled; and outputting, at an ingress subscriber terminal of the subscriber boards to be controlled, UBR cells to the switch terminal according to the fed-back UBR bandwidth information.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram that illustrates a related art UBR traffic control apparatus.

FIG. 2 is a flow diagram illustrating a related art UBR traffic control procedure.

FIG. 3 is a block diagram illustrating structure of a UBR traffic control apparatus according to a preferred embodiment of the present invention.

FIG. 4 is a flow diagram illustrating a UBR traffic control procedure according to a preferred embodiment of the present invention.

FIG. 5 is a flow diagram illustrating a cell count procedure for each subscriber board according to a preferred embodiment of the present invention.

FIG. 6 is a flow diagram illustrating a procedure of determining UBR bandwidth and subscriber boards to be controlled according to a preferred embodiment of the present invention.

FIG. 7 is a flow diagram illustrating a UBR bandwidth information feed-back method according to a preferred embodiment of the present invention.

### DETAILED DESCRIPTION OF PREFERRED EMBODIMENTS

In a related art switching device, which does not have the backpressure function of feed-backing traffic control information, the UBR traffic is controlled in the following manner. First, cell traffic output from the ATM switch is measured at the egress subscriber terminal, and thus, the traffic state at the switch terminal is analyzed. Based upon this analysis, the UBR bandwidth is determined. Information on the determined UBR bandwidth is carried on the reverse control cell and is output to the ingress subscriber terminal. Then, the ingress subscriber terminal determines the UBR traffic amount according to the UBR bandwidth information included in the control cell and inputs the UBR traffic in the corresponding amount to the switch terminal.

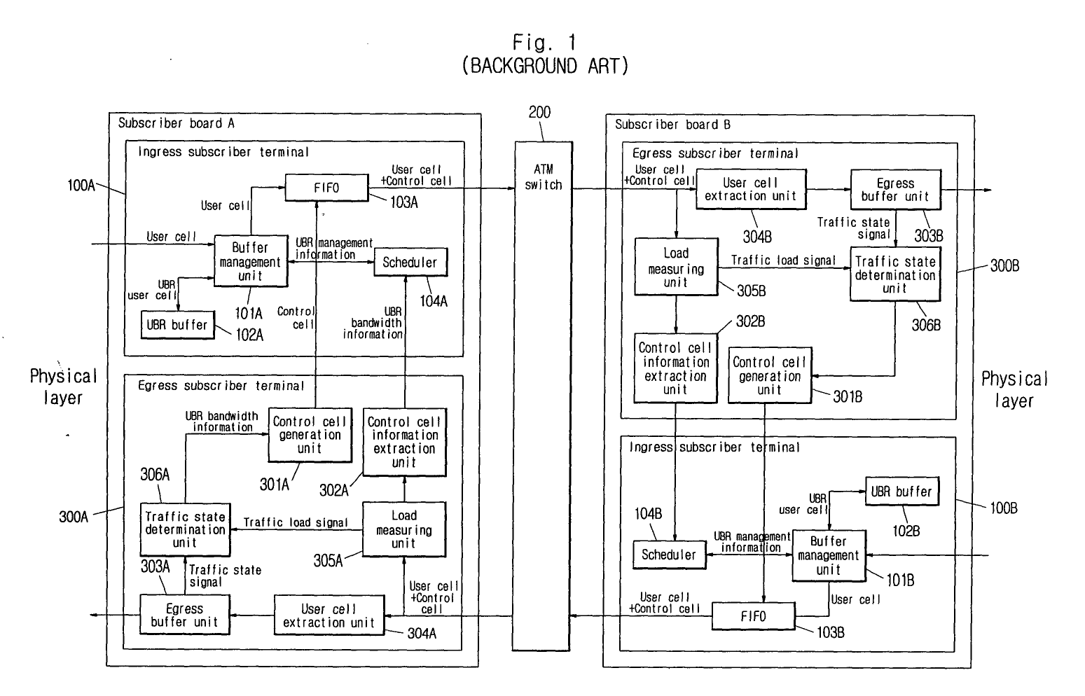

As illustrated in FIG. 1, the related art UBR traffic control apparatus has subscriber board A and subscriber board B, which include ingress subscriber terminals 100A and 100B and egress subscriber terminals 300A and 300B, respectively, and an ATM switch 200. Because subscriber board A and subscriber board B have the same structure, the structure of subscriber board A will be described hereinafter. The ingress subscriber terminal 100A of subscriber board A has a buffer management unit 101A, a UBR buffer 102A, a FIFO 103A and a scheduler 104A. The egress subscriber terminal 300A has a control cell generation unit 301A, a control cell information extraction unit 302A, an egress buffer unit 303A, a user cell extraction unit 304A, a load measuring unit 305A and a traffic state determination unit 306A.

The buffer management unit 101A outputs user cells input from the physical layer to the ATM switch 200 according to priorities corresponding to the relevant QoS levels. If a user cell is a UBR cell, the buffer management unit 101A stores such UBR cell in the UBR buffer 102A for each relevant connection, extracts the UBR cell from the UBR buffer 102A and outputs the extracted UBR cell to the ATM switch 200 at the time indicated by the UBR management information of the scheduler 104A.

The UBR buffer 102A stores UBR cells according to the control of the buffer management unit 101A. The FIFO 103A receives user cells output from the buffer management unit 101A and the reverse control cells output from the control cell generation unit 301A of the egress subscriber terminal 300A and outputs them to the ATM switch 200 according to the relevant priorities. The scheduler 104A receives from the control cell information extraction unit 302A UBR bandwidth information of the subscriber board B's egress subscriber terminal 300B and determines the time when the UBR management information should be extracted from the UBR buffer 102A based upon the received information, thereby enabling the extracted UBR management information to be output to the buffer management unit 101A.

The control cell generation unit 301A of the egress subscriber terminal 300A loads the UBR bandwidth information output from the traffic state determination unit 306A in the reverse control cell and outputs it to the FIFO 103A. The control cell information extraction unit 302A extracts the UBR bandwidth information from the control cell output from the ATM switch 200 and outputs the extracted information to the scheduler 104A.

The egress buffer unit 303A, including a number of buffers to store cells before outputting user cells to the physical layer, stores cells in its buffers according to the relevant classes, extracts cells according to the relevant priorities and outputs them to the physical layer. Further, based upon whether the volume of UBR cells stored in the UBR buffer exceeds the threshold value set internally in the UBR buffer, the egress buffer unit 303A outputs traffic state signals periodically to the traffic state determination unit 306A.

The user cell extraction unit 304A extracts only user cells from user cells and control cells output from the ATM switch 200 and outputs the extracted user cells to the egress buffer unit 303A. The load measuring unit 305A measures traffic load of user cells and control cells output from the ATM switch 200 and outputs traffic load signals periodically to the traffic state determination unit 306A.

The traffic state determination unit 306A determines UBR bandwidth based upon the traffic state signal output from the egress buffer unit 303A and the traffic load signal output from the load measuring unit 305A. The traffic state determination unit 306A outputs the determined UBR bandwidth information to the control cell generation unit 301A.

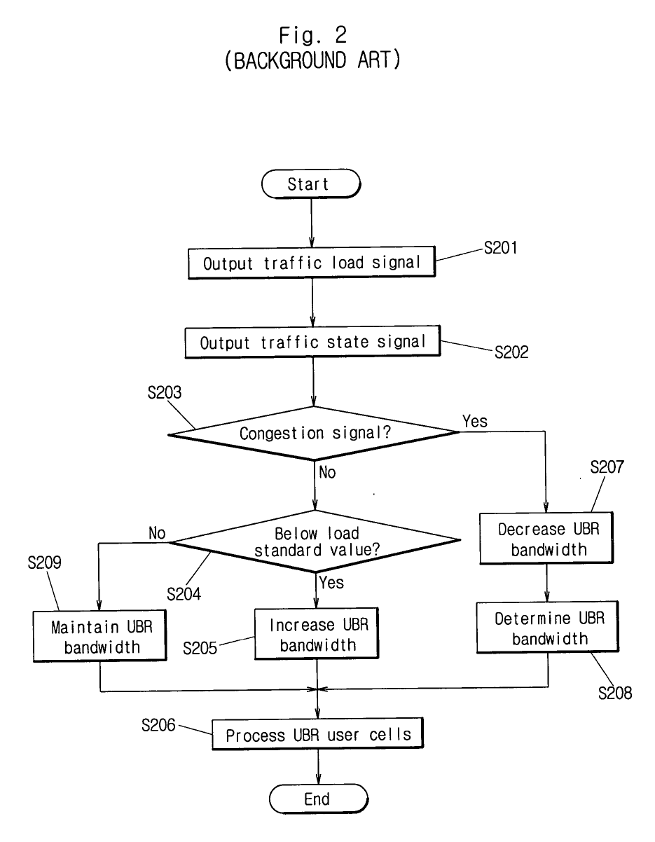

The operations of the related art UBR traffic control apparatus in an ATM switching device will now be described with reference to FIG. 2. The load measuring unit 305A of the egress subscriber terminal 300A within subscriber board A, which has a counter using shift registers, measures traffic load for each cell time through user cells and control cells input to the egress subscriber terminal 300A from the ATM switch 200 and outputs signal corresponding to the measured traffic load to the traffic state determination unit 306A (S201 ).

Specifically, if a cell is input to the egress subscriber terminal during one cell time, the relevant shift register constituting the counter is set with ‘1.’ If no cell is input, the shift register is set with ‘0.’ Then, one shift action is conducted, and the action of setting ‘0’ or ‘1’ is repeated for each of following cell times depending on the input of cells.

For example, if the counter is made up of 128 shift registers, the counter counts the number of ‘1’s set in the relevant registers in the 128 cell terms and thus measures the cell traffic input from the ATM switch 200 into the egress subscriber terminal 300A. If the cell count of the counter is 120 at a certain period, the traffic rate is 145 Mbps when the maximum cell traffic rate from the ATM switch 200 to the egress subscriber terminal 300A is 155 Mbps {(i.e., 155 Mbps*120 cells)/128 cells=145 Mbps}.

On the other hand, the egress buffer unit 303A of the egress subscriber terminal 300A checks whether the amount of user cells stored in the internal UBR buffer exceeds the buffer threshold value and outputs corresponding traffic state signals periodically to the traffic state determination unit 306A (S202). The UBR buffer within the egress buffer unit 303A has the lowest priority. In the case of cell traffic congestion, the traffic is input from the ATM switch 200 to the egress subscriber terminal 300A at the maximum rate of 155 Mbps and output from the egress subscriber terminal 300A to the physical layer at the maximum rate of 149 Mbps.

Consequently, in the case of cell traffic congestion, user cells that have not been output to the physical layer are stored in the egress buffer unit 303A. At this time, UBR cells are stored in the UBR buffer which has the lowest priority. Using these facts, the maximum amount of UBR cells stored in the UBR buffer in the normal state is monitored and such maximum amount is set as the threshold value of the UBR buffer.

Then, depending on whether the amount of UBR cells stored in the UBR buffer exceeds the threshold value, the relevant traffic state signals are output periodically to the traffic state determination unit 306A. More specifically, if UBR cells are stored in the UBR buffer over the UBR buffer threshold value, a congestion occurrence signal is output. If the amount of UBR cells stored in the UBR buffer is below the UBR buffer threshold value, a normal state signal is output.

The traffic state determination unit 306A receives traffic load signals and traffic state signals periodically output from the load measuring unit 305A and the egress buffer unit 303A (i.e., S201 and S202), and makes determination on state of cell traffic from the ATM switch 200 to the egress subscriber terminal 300A. In this regard, the traffic state determination unit 306A first determines whether the traffic state signal is congestion occurrence signal (S203).

If the traffic state signal from the egress buffer unit 303A is normal state signal, then the traffic state determination unit 306A checks the traffic load signal output from the load measuring unit 305A and determines whether the measured traffic load is not greater than the load standard value (S204). If it is determined that the measured traffic load is not greater than the load standard value, the current UBR bandwidth is increased (S205). Then, UBR cells are processed at the ingress subscriber terminal 100B of the other side's subscriber board B based upon the increased UBR bandwidth information (S206).

Specifically, if the traffic load measured by the load measuring unit 305A is not greater than the load standard value (ρ*c), it means that there exists some bandwidth that is not used by the current traffic. Thus, by using the formula, current UBR bandwidth +{(ρ*c−current UBR bandwidth)/constant}, the UBR bandwidth is increased. Then, according to the increased UBR bandwidth information, in order to enable the ingress subscriber terminal 100B of the other side's subscriber board B to process UBR cells, the traffic state determination unit 306A, upon including the increased UBR bandwidth information on the reverse control cell by using the control cell generation unit 301A, sends the increased UBR bandwidth information to the ingress subscriber terminal 100B of the other side's subscriber board B through the ingress subscriber terminal 100A of subscriber board A and through the ATM switch 200. Thus, the scheduler 104B within the ingress subscriber terminal 100B of subscriber board B may process UBR cells based upon the increased UBR bandwidth information.

In other words, the scheduler 104B within the ingress subscriber terminal 100B of subscriber board B determines the time when UBR cells are to be extracted from the UBR buffer, based upon the fed-back UBR bandwidth information of the egress subscriber terminal 300A of subscriber board A, and outputs the corresponding UBR management information to the buffer management unit 101B. The buffer management unit 101B processes UBR cells according to the input UBR management information. Specifically, the buffer management unit 101B extracts UBR cells to be sent through the increased UBR bandwidth out of the UBR buffer 102B and inputs such UBR cells to the ATM switch 200. Thus, the bandwidth that is not used by the real-time traffic is then used by the UBR traffic. In this manner, the UBR traffic flowing from the ingress subscriber terminal 100B to the egress subscriber terminal 300A through the ATM switch 200 is controlled.

On the other hand, if it is determined at S203 that the traffic state signal output from the egress buffer unit 303A is congestion occurrence signal, the traffic state determination unit 306A decreases the current UBR bandwidth (S207), and then compares it with the UBR available bandwidth (ΔBW) of the UBR connection and determines the UBR bandwidth (S208). Specifically, the current UBR bandwidth is decreased by half (0.5) and the decreased UBR bandwidth is compared with the UBR available bandwidth (ΔBW). If the decreased UBR bandwidth is smaller than the UBR available bandwidth (ΔBW), the UBR available bandwidth (ΔBW) becomes the UBR bandwidth. If the decreased UBR bandwidth is greater than the UBR available bandwidth (ΔBW), the decreased UBR bandwidth becomes the UBR bandwidth.

The above-described UBR available bandwidth (ΔBW) is determined through the following equation 1 at the time of UBR connection or disconnection for the purpose of strictly satisfying the QoS of the real-time traffic.

ΔBW=[ρ*c−(Σ(PCRᵢ)+Σ(SCRⱼ))]/k (Equation)

where ‘ρ’ represents target link utilization; ‘c’ is link capacity; ‘PCRᵢ’ is the PCR (Peak Cell Rate) of CBR (Constant Bit Rate) connection.; ‘SCRⱼ’ is the SCR (Sustainable Cell Rate) of VBR (Variable Bit Rate) connection; and ‘k’ is the number of UBR connections.

Based upon the determined UBR bandwidth information fed-back to the ingress subscriber terminal 100B of the other side's subscriber board B, the ingress subscriber terminal 100B processes UBR cells to be output to the egress subscriber terminal 300A (S206). By storing UBR cells corresponding to the decrease in the UBR bandwidth in the UBR buffer 102B or by discarding such UBR cells, the real-time traffic bandwidth is increased and thus the QoS for the real-time traffic is guaranteed.

If it is determined at S204 that the traffic load measured by the load measuring unit 305A is over the load standard value (i.e., if the cell traffic from the ATM switch 200 to the egress subscriber terminal 300A is not in the congestion state and the traffic speed is of the appropriate load level), the current UBR bandwidth is maintained (S209). Then, the current UBR bandwidth information is fed-back to the ingress subscriber terminal 100B of the other side's subscriber board B. Thus, the ingress subscriber terminal 100B processes user cells according to such maintained UBR bandwidth information (S206).

The related art UBR traffic control is conducted when the egress subscriber terminal 300A of subscriber board A feed-backs UBR bandwidth information, which is generated upon the determination of the state of UBR traffic output from the ingress subscriber terminal 100B of subscriber board B through the ATM switch 200 to the ingress subscriber terminal 100B via the ATM switch 200 and the egress subscriber terminal 300B of subscriber board B. Thus, the UBR traffic output from the ingress subscriber terminal 100B to the egress subscriber terminal 300A is controlled according to the UBR bandwidth information.

The UBR traffic from the ingress subscriber terminal 100A of subscriber board A, output to the egress subscriber terminal 300B of subscriber board B, may be controlled in the same manner. For this purpose, the UBR bandwidth information generated upon determination of UBR traffic at the egress subscriber terminal 300B is fed-back to the ingress subscriber terminal 100A via the ingress subscriber terminal 100B, the ATM switch 200 and the egress subscriber terminal 300A. Thus, the UBR traffic output from the ingress subscriber terminal 100A to the egress subscriber terminal 300B is controlled according to the relevant UBR bandwidth information.

As described above using FIGS. 1-2, the UBR bandwidth has been determined at the relevant egress subscriber terminal depending on the cell traffic state. Then, the determined UBR bandwidth information was carried by the reverse control cell and transmitted to the ingress subscriber terminal of the other side's subscriber board. Thus, the amount of UBR cells to be input into the switch terminal was controlled at the ingress subscriber terminal based upon the determined UBR bandwidth information.

The reverse control cell of the egress subscriber terminal is output from the ingress subscriber terminal of the same side's subscriber board to the ATM switch together with UBR cells and then is transmitted through the other side's subscriber board's egress subscriber terminal to the destination, the ingress subscriber terminal. At this time, if UBR cells and reverse control cells are input to the ATM switch at the same time, the reverse control cells are received first and the UBR user cells are temporarily stored in the FIFO and are input after all of the reverse control cells are input.

If a number of connections are established in the ATM switch and the corresponding number of control cells are generated and input to the ATM switch through the ingress subscriber terminal, then UBR cells are continuously stored in the FIFO for a while and then input to the ATM switch at one time. In this case, because the maximum speed of the traffic for the UBR user cells from the egress subscriber terminal to the physical layer (149 Mbps) is slower than the maximum speed of the traffic from the ATM switch to the egress subscriber terminal (155 Mbps), the UBR user cells corresponding to the difference of the speeds (155 Mbps-149 Mbps) are accumulated in the output buffer of the egress subscriber terminal even if the ATM switch is in the normal state without UBR cell's traffic congestion.

Then, the egress subscriber terminal considers that it is in the congestion state because the threshold value of the output buffer has been exceeded, and thus, the UBR bandwidth is accordingly reduced. As a result, the efficiency in the UBR cell process is decreased.

Furthermore, in the case where the cell traffic congestion state is cleared and thus the UBR bandwidth is increased according to a specific formula, if the cell traffic output from the ATM switch is slow, the rate of increase is very low and thus it takes too much time to reach the normal bandwidth. On the other hand, if the cell traffic is fast, the rate of increase may too be large to enter the normal bandwidth range precisely. In summary, the UBR bandwidth increase according to the specific formula presents problems both in the case where the cell traffic is slow and in the case where the cell traffic is fast.

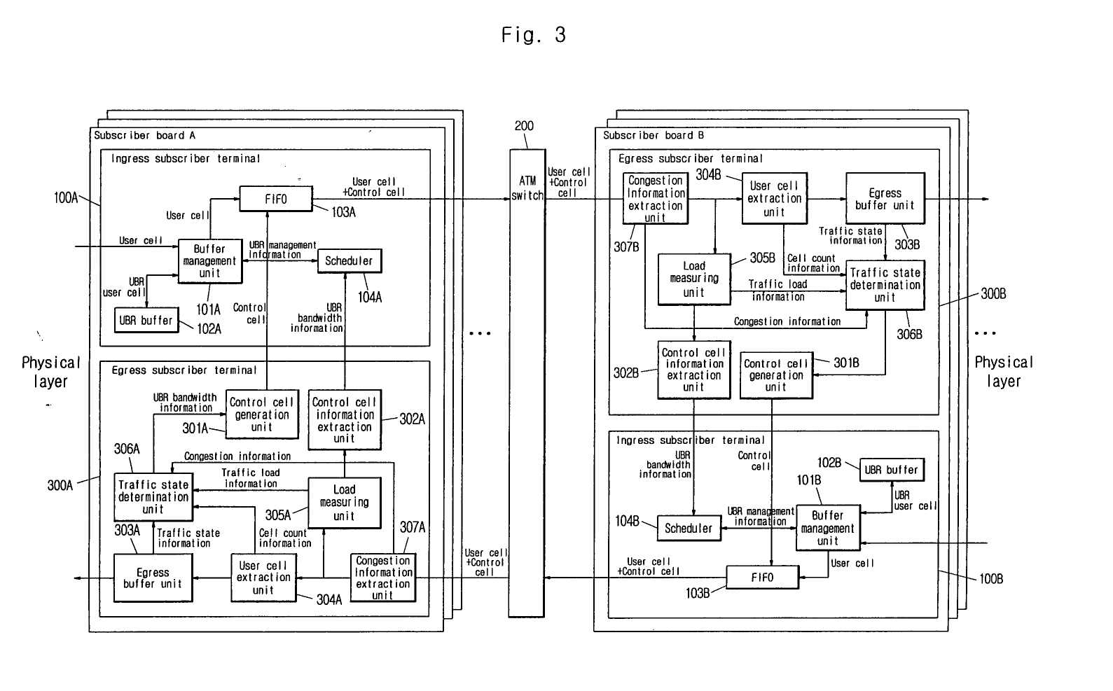

As illustrated in FIG. 3, a UBR traffic control apparatus according to a preferred embodiment of the present invention can include a number of respective subscriber boards A and B, including ingress subscriber terminals 100A and 100B and egress subscriber terminals 300A and 300B respectively, and an ATM switch 200. A subscriber board (for example, subscriber board A) of the UBR traffic control apparatus can have the following structure. The ingress subscriber terminal 100A of subscriber board A can include a buffer management unit 101A, a UBR buffer 102A, a FIFO 103A and a scheduler 104A. The egress subscriber terminal 300A of subscriber board A can include a control cell generation unit 301A, a control cell information extraction unit 302A, an egress buffer unit 303A, a user cell extraction unit 304A, a load measuring unit 305A, a traffic state determination unit 306A and a congestion information extraction unit 307A.

The buffer management unit 101A of the ingress subscriber terminal 100A transmits user cells input from the physical layer to the ATM switch 200 according to the priorities given corresponding to the relevant QoS levels and stores UBR cells for each of the relevant connections in the UBR buffer 102A. Further, the buffer management unit 101A extracts UBR cells from the UBR buffer 102A according to the UBR management information of the scheduler 104A and outputs them to the ATM switch 200.

The UBR buffer 102A stores UBR cells according to the control of the buffer management unit 101A. The FIFO 103A receives user cells (e.g., CBR/VBR, UBR) output from the buffer management unit 101A and reverse control cells output from the control cell generation unit 301A of the egress subscriber terminal 300A, and outputs them to the ATM switch 200 according to the relevant priorities. The scheduler 104A receives the UBR bandwidth information of the egress subscriber terminal 300B within the other side subscriber board B from the control cell information extraction unit 302A. The scheduler 104A determines the time for extraction of UBR cells out of the UBR buffer 102A according to the received information and outputs the corresponding UBR management information to the buffer management unit 101A.

The control cell generation unit 301A in the egress subscriber unit 300A receives the UBR bandwidth information and information about subscriber boards to be controlled (e.g., to which the UBR bandwidth information will be fed-back) from the traffic state determination unit 306A. The control cell generation unit 306A can generate control cells to be output to the subscriber boards to be controlled, set the UBR bandwidth information in the generated control cells and output them to the FIFO 103A.

The control cell information extraction unit 302A receives control cells output from the ATM switch 200, confirms the subscriber boards to which the control cells are to be fed-back and the destination (e.g., target) of the relevant cells through the source code and destination information included in the input control cells. If the destination is the subscriber board to which the control cell information extraction unit 302A itself belongs, it extracts the UBR bandwidth information included in the cell and outputs it to the scheduler 104A.

The egress buffer unit 303A stores user cells of each class in the relevant buffer and outputs them to the physical layer according to the relevant priorities. Further, the egress buffer unit 303A sets the UBR buffer threshold value with a present limit or the maximum amount of UBR cells stored in the UBR buffer in the normal state and periodically outputs the traffic state information regarding whether the buffer threshold value has been exceeded or not to the traffic state determination unit 306A.

The user cell extraction unit 304A extracts user cells out of the user cells and control cells output from the ATM switch 200 and outputs the extracted user cells to the egress buffer unit 303A. Then, in order to manage the cell traffic state of each transmitting subscriber board coupled to the subscriber board to which the user cell extraction unit 304A belongs, the user cell extraction unit 304A establishes a traffic information table or the like, counts user cells for each transmitting subscriber board using the source information included in the extracted user cells and stores such user cell counts in the table.

In other words, the user cell extraction unit 304A can extract user cells in each traffic state determination period, confirm the transmitting subscriber board that transmitted the relevant cell through the source information included in the relevant extracted cell, and then increase the relevant subscriber board's cell count by 1 in the traffic information table of the relevant subscriber board. Preferably, when the relevant period expires, the user cell extraction unit 304A outputs each subscriber board's cell count information stored in the table to the traffic state determination unit 306A and then initializes the cell count value for each subscriber board. Whether the traffic state determination period has expired or not can be recognized through the supply of the relevant information from the upper system, through operation of an independent timer or the like.

The load measuring unit 305A can measure traffic load of user cells and control cells output from the ATM switch 200. The load measuring unit 305A can periodically report the measured traffic load information to the traffic state determination unit 306A.

Based upon the traffic state information input from the egress buffer unit 303A, the traffic load information input from the load measuring unit 305A and the congestion information input from the congestion information extraction unit 307A, the traffic state determination unit 306A determines UBR bandwidth periodically or repeatedly for each traffic state determination period, and then outputs the determined UBR bandwidth information to the control cell generation unit 301A. The traffic state determination period can be, for example, from the time when the UBR control was conducted by the transmission of the UBR bandwidth information determined at the egress subscriber terminal 300A to the corresponding ingress subscriber terminal 100B to the time when the controlled traffic is input to the egress subscriber terminal 300A.

At this time, if the UBR bandwidth is increased or decreased, the traffic state determination unit 306A can determine subscriber boards to be controlled by using the cell count information for each subscriber board input from the user cell extraction unit 304A. The traffic state determination unit 306A can transmit the information on such subscriber boards to the control cell generation unit 301A.

For example, if the UBR bandwidth is increased, considering that, of the transmitting subscriber boards with which the subscriber board of the traffic state determination unit 306A itself has connections, there may exist subscriber boards that do not transmit cells, the traffic state determination unit 306A can determine subscriber boards that actually output cells (e.g., subscriber boards that have cell count value of 1 or more) as the subscriber boards to be controlled. Then, the traffic state determination unit 306A can transmit the information about such subscriber boards to the control cell generation unit 301A.

On the other hand, if the UBR bandwidth is decreased, in order to reduce or prevent decrease of UBR traffic efficiency caused by indiscriminate reduction in UBR bandwidth, the traffic state determination unit 306A determines a subscriber board that has output the greatest number of cells (e.g., the subscriber board having the greatest cell count value) as the subscriber board to be controlled, among the subscriber boards with which the subscriber board of the traffic state determination unit 306A itself has connections, and then transmits the information about such subscriber board to the control cell generation unit 301A. The following table illustrates exemplary cell count values of respective subscriber boards for relevant traffic state determination periods.

TABLE 1

| Traffic State | Subscriber Board | | | |
|---|---|---|---|---|
| Determination Period | B1 | B2 | B3 | B4 |
| Period 1 | 50 | 30 | 20 | 0 |
| Period 2 | 10 | 30 | 20 | 10 |

As illustrated in Table 1, if the UBR bandwidth is increased in the first traffic state determination period (Period 1), the subscriber boards to be controlled can be subscriber board B1, subscriber board B2 and subscriber board B3, which have cell counts of 1 or more. In contrast, if the UBR bandwidth is decreased, the subscriber board to be controlled is subscriber board B1, which has the greatest cell count value.

Preferably, if the UBR bandwidth is decreased, the decreased bandwidth information is fed-back only to the subscriber board to be controlled (e.g., subscriber board B1). Thus, UBR cells are preferably processed according to the decreased UBR bandwidth only on subscriber board B1.

The cell count values for the respective subscriber boards in the second traffic state determination period (Period 2) are as set forth in Table 1. According to the UBR traffic control if the UBR bandwidth is further decreased in Period 2, the subscriber board to be controlled can be subscriber board B2, which had the second greatest cell count value in Period 1, but has the greatest cell count value in the current period. If, on the other hand, the UBR bandwidth is increased in Period 2, the subscriber boards to be controlled can be subscriber boards B1, B2, B3 and B4 which have cell count values of 1 or more.

The congestion information extraction unit 307A preferably checks the value set in the CI (Congestion Indicator) fields of user cells and control cells input from the ATM switch 200 and outputs the congestion information to the traffic state determination unit 306A according to whether or not there has been congestion of the relevant cell in the ATM switch 200. For example, if the CI field value is 1, the congestion experience information is output, indicating that there has been congestion in the relevant cell. In contrast, if the CI field value is 0, the congestion non-experience information is output, indicating that there has been no congestion in the relevant cell.

Preferably, CI field values of user cells and control cells are set at the ATM switch 200. Specifically, the ATM switch 200 sets CI fields of cells passing through the switch terminal when there is traffic congestion with 1 and, if the congestion state is cleared, sets CI fields of cells with 0.

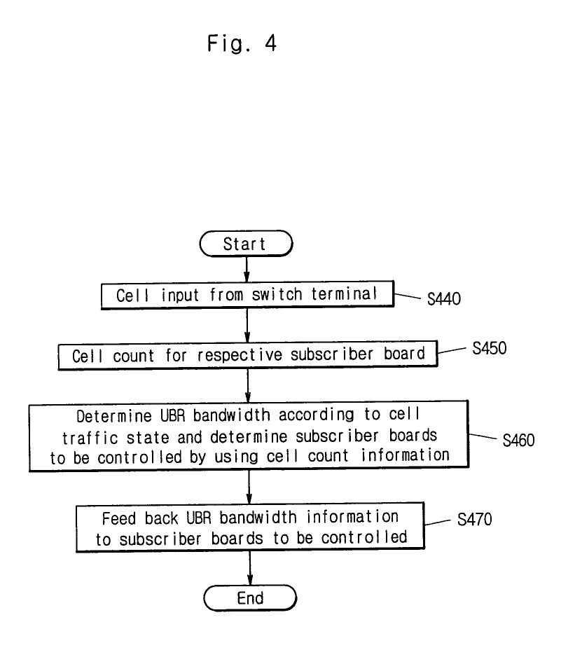

FIG. 4 is a flow diagram illustrating a UBR traffic control procedure according to a preferred embodiment of the present invention. The preferred embodiment of the UBR traffic control will be described using the UBR traffic control apparatus shown in FIG. 3. However, the present invention is not intended to be so limited.

As shown in FIG. 4, the user cell extraction unit 304A periodically extracts user cells out of the user cells and control cells output from the ATM switch 200, counts such cells for each subscriber board that transmitted the relevant cells, and outputs the cell count information for each subscriber board to the traffic state determination unit 306A. The cell count is preferably output when the current period expires (S440, S450).

Then, the traffic state determination unit 306A preferably determines UBR bandwidth for each traffic state determination period by using congestion information input from the congestion information extraction unit 307A, traffic load information input from the load measuring unit 305A, and traffic state information input from the egress buffer unit 303A. Preferably, at the time of the UBR bandwidth's increase or decrease, the traffic state determination unit 306A can determine subscriber boards to be controlled by using the cell count information for the respective subscriber boards, which is input from the user cell extraction unit 304A, and output the determined UBR bandwidth information and the information on the subscriber boards to be controlled to the control cell generation unit 301A (S460).

Thereupon, the control cell generation unit 301A generates control cells whose destinations are the subscriber boards to be determined, sets the UBR bandwidth information in the generated control cells and feed-backs the control cells to the subscriber boards to be controlled. Thus, the procedure enables the subscriber boards to be controlled to process UB cells according to the fed-back UBR bandwidth information (S470).

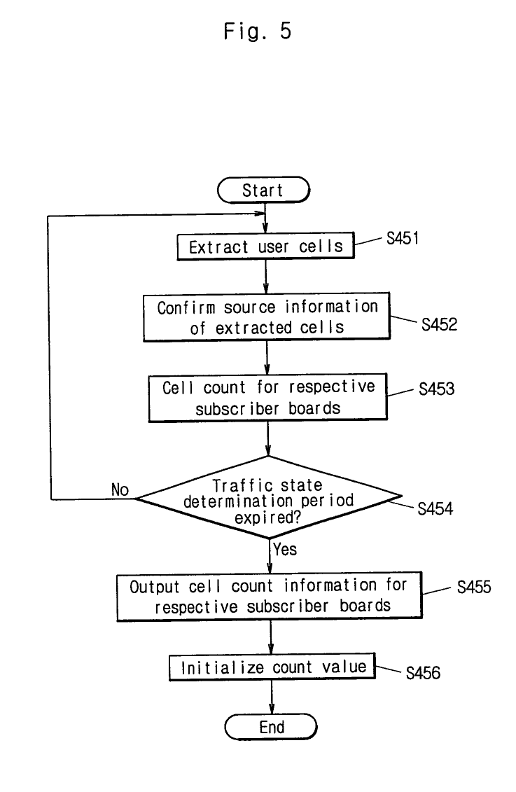

FIG. 5 is a flow diagram illustrating a cell count procedure for each subscriber board according to a preferred embodiment of the present invention. The preferred embodiment of the cell count procedure will be described using the user cell extraction unit 304A. However, the present invention is not intended to be so limited.

As shown in FIG. 5, the user cell extraction unit 304A extracts user cells out of the input user cells and control cells (S451) and confirms identities of transmitting subscriber boards that output the user cells (S452). The identities are preferably confirmed by referring to source information in the extracted user cells.

Then, the user cell extraction unit 304A increases the cell count value for the relevant subscriber board, recorded in the traffic information table, by 1 for each cell (S453). Then, it checks whether the current traffic state determination period has expired (S454). If the period has not yet expired, the user cell extraction unit 304A can repeat the above-described steps. If the period has expired, it outputs the cell count information for respective subscriber boards stored in the traffic information table for subscriber boards to the traffic state determination unit 306A (S455) and then initializes the cell count values for subscriber boards in said table (S456).

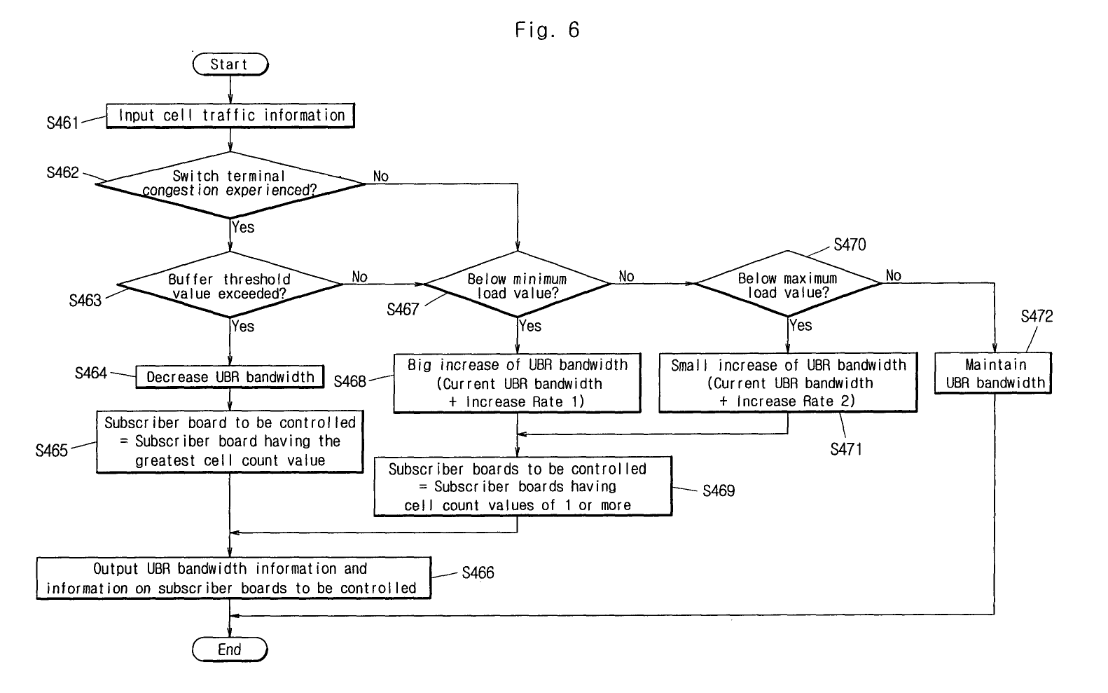

FIG. 6 is a flow diagram illustrating a procedure of determining UBR bandwidth and subscriber boards to be controlled according to a preferred embodiment of the present invention. The preferred embodiment of the determining UBR bandwidth and subscriber boards will be described using the traffic state determination unit. However, the present invention is not intended to be so limited.

As shown in FIG. 6, the traffic state determination unit 306A preferably receives traffic state information, cell count information for each subscriber board, traffic load information and congestion information respectively from the egress buffer unit 303A, the user cell extraction unit 304A, the load measuring unit 305A and the congestion information extraction unit 307A (S461). Then, the traffic state determination unit 306A can check through the congestion information to determine whether there has been congestion at the ATM switch 200 of user cells and control cells input from the ATM switch 200 during a traffic state determination period (S462).

If it is determined that the cell congestion has occurred (e.g., if the traffic congestion has occurred at the ATM switch 200), the traffic state determination unit 306A checks, by using the traffic state information, whether UBR cells stored in the egress buffer unit 303A exceed the pre-determined buffer threshold value in order to determine whether the cause of the congestion is the subscriber board to which the traffic state determination unit 306A itself belongs (S463). If the buffer threshold value has been exceeded, the traffic state determination unit 306A determines that the traffic congestion was caused by the subscriber board to which the traffic state determination unit 306A itself belongs and thus preferably reduces the current UBR bandwidth to the UBR available bandwidth(ΔBW) (S464).

Thereafter, the traffic state determination unit 306A checks the cell count information for each subscriber board and determines the subscriber board having the greatest cell count value as the subscriber board to be controlled (S465). The traffic state determination unit 306A preferably outputs the reduced UBR bandwidth information and the information on the subscriber board to be controlled to the control cell generation unit 301A (S466).

On the other hand, if it is determined (e.g., S462) that the relevant cells have not experienced congestion at the ATM switch 200 (e.g., if the cell traffic at the switch terminal is in the normal state) or if it is determined at said step S463 that UBR cells are below the buffer threshold value (e.g., if the traffic congestion at the switch terminal was caused by other subscriber boards), the traffic state determination unit 306A checks the traffic load information to determine whether the traffic load of cells input from the ATM switch 200 exceeds the pre-determined first load value or minimum load value (e.g., 100 Mbps) (S467). If it is determined that the traffic load is not greater than the minimum load value, then the traffic state determination unit 306A determines that the cell traffic from the switch terminal to the subscriber board to which the traffic state determination unit 306A itself belongs is in the normal state and that there is no concern of congestion occurrence. Thus, the traffic state determination unit 306A increases the current UBR bandwidth by applying the large increase rate, Increase Rate 1 (e.g., 50 Kbps) (S468).

Thereafter, by checking the cell count information for each subscriber board, the traffic state determination unit 306A determines the subscriber boards having the cell count value of 1 or more as subscriber boards to be controlled (S469). The traffic state determination unit 306A preferably outputs the increased UBR bandwidth information and information on the subscriber boards to be controlled to the control cell generation unit 301A (S466).

On the other hand, if it is determined (e.g., S467) that the traffic load exceeds the minimum load value, the traffic state determination unit 306A checks whether the traffic load is not greater than a second load value or the maximum load value (e.g., ρ*c=149 Mbps) (S470). If the traffic load is not greater than the maximum load value, considering that there is a risk of congestion occurrence even though the cell traffic from the switch terminal to the subscriber board to which the traffic state determination unit itself belongs is in the normal state, the traffic state determination unit 306A increases the UBR bandwidth by a small increase rate, Increase Rate 2 (e.g., 900 bps), which is smaller than Increase Rate 1 (S471). Then, the traffic state determination unit 306A proceeds to go through step S469.

If it is determined at said step S470 that the traffic load exceeds the maximum load value, the traffic state determination unit 306A determines that the UBR cells are transmitted to its maximum capacity in the state where the cell traffic from the switch terminal to the subscriber board to which the traffic state determination unit 306A itself belongs is normal or that the current overload is a temporary overload caused by the reverse control cells' influence. Thus, the current UBR bandwidth is maintained (S472).

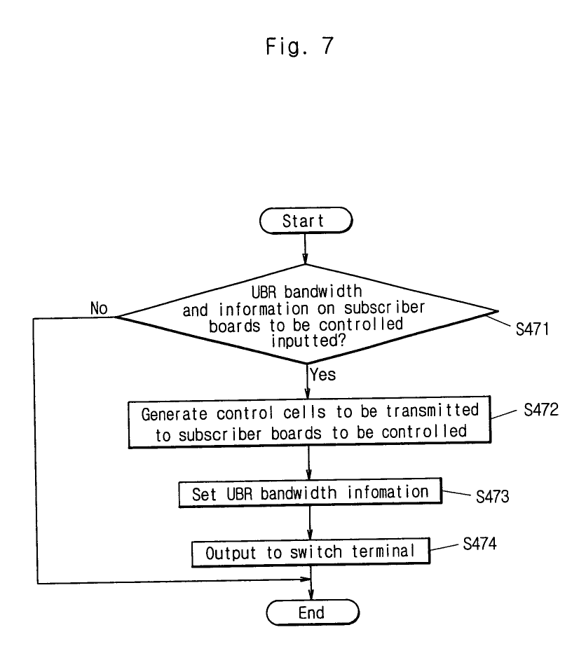

FIG. 7 is a flow diagram illustrating a UBR bandwidth information feed-back method according to a preferred embodiment of the present invention. The preferred embodiment of the UBR bandwidth information feed-back method will be described using the control cell generation unit 301A. However, the present invention is not intended to be so limited.

As shown in FIG. 7, the control cell generation unit 301A checks whether UBR bandwidth information and information on subscriber boards to be controlled is input from the traffic state determination unit 306A (S471). If such information is input according to the UBR bandwidth increase or decrease, the control cell generation unit 301A generates control cells having the subscriber boards to be controlled as their destinations (S472).

Then, upon setting the UBR bandwidth information in the generated control cells (S473), the control cell generation unit 301A outputs the control cells to the ATM switch 200 through the FIFO 103A of the ingress subscriber unit 100A in subscriber board A (S474). In this manner, the UBR bandwidth information is fed-back to the ingress subscriber terminal 100B of subscriber board B, which is to be controlled.

Then, the ingress subscriber terminal 100B of subscriber terminal B, which is to be controlled, processes UBR user cells to be output to the ATM switch 200 according to the fed-back UBR bandwidth.

Specifically, if the fed-back UBR bandwidth information indicates that the UBR bandwidth has been decreased, the scheduler 104B of the ingress subscriber terminal 100B stores in the UBR buffer 102B, or discards, UBR cells corresponding to the decreased UBR bandwidth. Thus, the relative real-time traffic bandwidth is increased and the required QoS for real-time traffic is guaranteed.

If the UBR bandwidth has been increased, the scheduler extracts from the UBR buffer 102B UBR cells corresponding to the increased UBR bandwidth and outputs them to the ATM switch 200, thereby enabling UBR traffic to use the bandwidth not used by real-time traffic. In this manner, UBR traffic output from the ingress subscriber terminal 100B to the egress subscriber terminal 300A through the ATM switch 200 is controlled.

On the other hand, if no UBR bandwidth information has been fed-back from the receiving subscriber board A, the scheduler 104B in the ingress subscriber terminal 100B considers that the current UBR bandwidth is maintained and thus processes UBR cells accordingly in the same manner as before.

As described above, preferred embodiments of the present invention have various advantages. For example, preferred embodiments according to the present invention may increase or maximize UBR traffic efficiency by increasing, decreasing or maintaining UBR bandwidth effectively in consideration of the cells' congestion experience at the switch terminal, the egress subscriber terminal's buffer threshold value and traffic load. Further, by managing cell traffic state for at least one transmitting subscriber board and determining subscriber boards to be controlled according to such traffic state, and thus by feeding-back UBR bandwidth information to such subscriber boards to be controlled, the preferred embodiments may prevent the uniform UBR bandwidth decrease at all of the transmitting subscriber boards when the UBR bandwidth is decreased and consequently improve the quality of UBR service.

In addition, in the case of UBR bandwidth increase, the preferred embodiments can prevent UBR bandwidth information from being fed-back even to subscriber boards that have no actual cell traffic. Furthermore, when UBR bandwidth is maintained, the feed-back of UBR bandwidth information itself is omitted. Consequently, the preferred embodiments can reduce or prevent load increase caused by control cells and thus improves UBR traffic efficiency.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An unspecified bit rate (UBR) traffic control apparatus, comprising:
an egress subscriber terminal that repeatedly monitors cell congestion state and traffic state of cells output from a switch terminal, generates UBR bandwidth information corresponding thereto, and feeds-back the UBR bandwidth information; and
an ingress subscriber terminal that outputs UBR cells to the switch terminal according to the fed-back UBR bandwidth information.

2. The UBR traffic control apparatus according to claim 1, wherein the egress subscriber terminal comprises:
a congestion information extraction unit that extracts congestion information indicating whether there is cell congestion in a relevant cell;
a load measuring unit that measures traffic load of the relevant cell and outputs corresponding traffic load information;
an egress buffer unit that checks whether a prescribed buffer threshold value of the relevant cell has been exceeded and outputs corresponding traffic state information; and
a traffic state determination unit that determines UBR bandwidth based upon the congestion information, the traffic state information and the traffic load information and feeds-back the UBR bandwidth information to the ingress subscriber terminal.

3. The UBR traffic control apparatus according to claim 2, wherein the congestion information extraction unit extracts the congestion information by monitoring a congestion indicator field value of the relevant cell.

4. The UBR traffic control apparatus according to claim 2, wherein the traffic state determination unit reduces the UBR bandwidth to UBR available bandwidth when the congestion information indicates that there is corresponding cell congestion and when the traffic state information indicates that the prescribed buffer threshold value of the relevant cell has been exceeded.

5. The UBR traffic control apparatus according to claim 2, wherein the traffic state determination unit increases the UBR bandwidth by a first prescribed rate or a second prescribed rate that is smaller than first prescribed rate according to the traffic load confirmed through the traffic load information when the congestion information indicates that there is corresponding cell congestion and when the traffic state information indicates that the prescribed buffer threshold value has not been exceeded.

6. The UBR traffic control apparatus according to claim 5, wherein the traffic state determination unit increases the UBR bandwidth by the first prescribed rate or by a second prescribed rate that is smaller than the first prescribed rate according to the traffic load confirmed through the traffic load information when the congestion information indicates that there has been no congestion.

7. The UBR traffic control apparatus according to claim 6, wherein the traffic state determination unit increases the UBR bandwidth by applying said first prescribed rate when the traffic load is not greater than a prescribed lower load value.

8. The UBR traffic control apparatus according to claim 6, wherein the traffic state determination unit increases the UBR bandwidth by applying said second prescribed rate when the traffic load is greater than a prescribed lower load value and is not greater than a prescribed upper load value.

9. The UBR traffic control apparatus according to claim 6, wherein the traffic state determination unit maintains the UBR bandwidth when the traffic load exceeds a prescribed upper load value.

10. A UBR traffic control apparatus comprising:
an egress subscriber terminal that determines UBR bandwidth periodically according to cell congestion experience and traffic state of cells output from a switch terminal, wherein the egress terminal determines subscriber boards that are to be controlled when the UBR bandwidth changes based upon cell count information for each subscriber board of the subscriber boards and feeds-back the UBR bandwidth information to the determined subscriber boards to be controlled; and
an ingress subscriber terminal that outputs UBR cells to the switch terminal according to the fed-back UBR bandwidth information.

11. The UBR traffic control apparatus according to claim 10, wherein the egress subscriber terminal comprises:
a congestion information extraction unit that extracts congestion information indicating whether there is cell congestion experience in a relevant cell;
a load measuring unit that measures traffic load of the relevant cell and outputs corresponding traffic load information;
a user cell extraction unit that counts user cells for said each subscriber board and outputs the cell count information for each relevant subscriber board;
an egress buffer unit that checks whether UBR user cells of said user cells exceed a pre-determined buffer threshold value and outputs corresponding traffic state information;
a traffic state determination unit that increases, decreases or maintains the UBR bandwidth based upon the congestion information, the traffic state information and the traffic load information, and wherein when the UBR bandwidth is increased or decreased, the traffic state determination unit determines subscriber boards that are to be controlled by using the user cell count information for said each subscriber board, and outputs the increased or decreased UBR bandwidth information and information on the subscriber boards to be controlled; and
a control cell generation unit that generates control cells using the UBR bandwidth information and the information on subscriber boards to be controlled and feeds-back the determined UBR bandwidth information to the ingress subscriber terminals of the subscriber boards to be controlled through the generated control cells.

12. The UBR traffic control apparatus according to claim 11, wherein the congestion information extraction unit extracts the congestion information by monitoring a congestion indicator field value of the relevant cell.

13. The UBR traffic control apparatus according to claim 11, wherein the user cell extraction unit periodically extracts user cells, counts cells for each subscriber board by using source information included in the extracted cells, and wherein the user cell extraction unit outputs the cell count information for said each subscriber board to the traffic state determination unit when a current period ends.

14. The UBR traffic control apparatus according to claim 11, wherein the traffic state determination unit reduces the UBR bandwidth to UBR available bandwidth and determines the subscriber board having a cell count value above a prescribed level as the subscriber board to be controlled when the congestion information indicates that there has been congestion and when the traffic state information indicates that the pre-determined buffer threshold value has been exceeded.

15. The UBR traffic control apparatus according to claim 11, wherein the traffic state determination unit increases UBR bandwidth by a first prescribed rate or a second prescribed rate that is smaller than the first prescribed rate according to the traffic load confirmed through the traffic load information, and determines the subscriber board having the cell count value of 1 or more as the subscriber board to be controlled when the congestion information indicates that there has been congestion and the traffic state information indicates that the prescribed buffer threshold value has not been exceeded.

16. The UBR traffic control apparatus according to claim 11, wherein the traffic state determination unit increases the UBR bandwidth by a first prescribed rate or by a second prescribed rate that is smaller than the first prescribed rate according to the traffic load confirmed through the traffic load information and determines the subscriber board having the cell count value of 1 or more as the subscriber board to be controlled when the congestion information indicates that there has been no congestion.

17. The UBR traffic control apparatus according to claim 16, wherein the traffic state determination unit increases the UBR bandwidth by applying said first prescribed rate when the traffic load is not greater than the pre-determined lower load value.

18. The UBR traffic control apparatus according to or claim 16, wherein the traffic state determination unit increases the UBR bandwidth by applying said second prescribed rate when the traffic load is greater than the pre-determined lower load value and is not greater than the upper load value.

19. The UBR traffic control apparatus according to claim 16, wherein the traffic state determination unit maintains the current UBR bandwidth when the traffic load exceeds the pre-determined upper load value.

20. A UBR traffic control method comprising:
repeatedly determining, at an egress subscriber terminal, UBR bandwidth according to cell congestion experience and traffic state of cells output from a switch terminal and feeding-back the determined UBR bandwidth; and
outputting, at an ingress subscriber terminal, UBR cells to the switch terminal according to the fed-back UBR bandwidth information.

21. The UBR traffic control method according to claim 20, wherein the cell congestion state is confirmed through the value set in a congestion indicator field of the cell according to the occurrence of cell traffic congestion at the switch terminal.

22. The UBR traffic control method according to claim 20, wherein said determination of UBR bandwidth comprises:
confirming whether there is traffic congestion experience in a cell;
confirming whether a pre-determined buffer threshold value of the cell has been exceeded;
decreasing the UBR bandwidth to UBR available bandwidth when there has been traffic congestion and the buffer threshold value has been exceeded; and
increasing the UBR bandwidth according to the traffic load of the cell when there has been no traffic congestion in the cell or when there has been traffic congestion but the buffer threshold value has not been exceeded.

23. The UBR traffic control method according to claim 22, wherein said increasing of the UBR bandwidth comprises:
confirming the traffic load of the cell;
increasing the UBR bandwidth by applying first prescribed rate that is a certain specific bandwidth increase rate when the traffic load is not greater than the pre-determined minimum load value; and
increasing the UBR bandwidth by applying a second prescribed rate that is smaller than said first prescribed rate when the traffic load is greater than the minimum load value and is not greater than the pre-determined maximum load value.

24. The UBR traffic control method according to claim 23, further comprising maintaining of the current UBR bandwidth when the traffic load exceeds said maximum load value.

25. A UBR traffic control method comprising:
periodically counting, at an egress subscriber terminal, cells output from a switch terminal for each transmitting subscriber board;
determining UBR bandwidth according to congestion experience at the switch terminal and traffic state of said cells;
if the UBR bandwidth is increased or decreased, determining subscriber boards to be controlled by using the cell count information for each subscriber board;
feeding back said increased or decreased UBR bandwidth information to said subscriber boards to be controlled; and
outputting, at an ingress subscriber terminal of at least one of said subscriber boards to be controlled, UBR cells to the switch terminal according to the fed-back UBR bandwidth information.

26. The UBR traffic control method according to claim 25, wherein said counting of cells for each subscriber board comprises:
periodically extracting user cells from said cells output from the switch terminal and confirming source information of the relevant cells;
counting said user cells for each transmitting subscriber board by using said source information for a relevant period; and
initializing said count value for each subscriber board when the relevant period ends.

27. The UBR traffic control method according to claim 25, wherein said determination of UBR bandwidth comprises:
confirming whether there is traffic congestion experience in a cell;
confirming whether a pre-determined buffer threshold value of the cell has been exceeded;
decreasing the UBR bandwidth to UBR available bandwidth when there has been traffic congestion and the buffer threshold value has been exceeded; and
increasing the UBR bandwidth according to the traffic load of the cell when there has been no traffic congestion in the cell or if there has been traffic congestion but the buffer threshold value has not been exceeded.

28. The UBR traffic control method according to claim 27, wherein said increasing of the UBR bandwidth comprises:
confirming the traffic load of the cell;
increasing the UBR bandwidth by applying first prescribed rate that is a certain specific bandwidth increase rate when the traffic load is not greater than the pre-determined minimum load value;
increasing the UBR bandwidth by applying a second prescribed rate that is smaller than said first prescribed rate when the traffic load is greater than the minimum load value and is not greater than the predetermined maximum load value; and
maintaining of the current UBR bandwidth if the traffic load exceeds said maximum load value and not feeding back the UBR bandwidth.

29. The UBR traffic control method according to claim 25, wherein said determination of subscriber boards to be controlled comprises:
confirming the cell count information for each subscriber board at the time of increasing or decreasing the UBR bandwidth; and
determining the subscriber board having the greatest cell count value as the subscriber board to be controlled when the UBR bandwidth is to be decreased and, determining subscriber boards having the cell count value of 1 or more as the subscriber boards to be controlled when the UBR bandwidth is to be increased.

30. The UBR traffic control method according to claim 25, wherein said feeding-back of the UBR bandwidth comprises:
generating control cells to be sent to said subscriber boards to be controlled; and
setting said UBR bandwidth information in the control cells and feeding them back to the ingress subscriber terminals of said subscriber boards to be controlled.
